(19) United States
(12) Patent Application Publication
(10) Pub. No.: US 2007/0115112 A1
(43) Pub. Date: May 24, 2007

(54) Supplemental fire alerting system

(76) Inventors: George J. Elwell, Waterford, MI (US); Gene M. Strohallen, North Manchester, IN (US)

Correspondence Address: HARNESS, DICKEY & PIERCE, P.L.C., P.O. BOX 828, BLOOMFIELD HILLS, MI, 48303, US

(21) Appl. No.: 11/599,157

(22) Filed: Nov. 14, 2006

Related U.S. Application Data
(60) Provisional application No. 60/736,536, filed on Nov. 14, 2005.

(51) Int. Cl. G08B 1/08; G08B 25/00; G08B 29/00

(52) U.S. Cl. 340/538; 340/288; 340/506

(57) ABSTRACT

A supplemental alerting system for a fire alarm system comprises an alarm control device and a power line notification appliance (PLNA). The alarm control device generates a fire alarm code signal based on detecting a fire alarm mode signal transmitted from a fire alarm system. The PLNA generates at least one of a PLNA audible and PLNA visual fire alarm based on the fire alarm code signal.

### CROSS-REFERENCE TO RELATED APPLICATIONS

This application claims the benefit of U.S. Provisional Application No. 60/736,536 filed on Nov. 14, 2005. The disclosure of the above application is incorporated herein by reference.

### FIELD

The present invention relates to fire alarm systems for persons with disabilities.

### BACKGROUND

The American Disabilities Act (ADA) prohibits discrimination based on disability and therefore the ADA requires that public facilities provide assistance to persons who are disabled. Many public facilities such as hotels and motels find that making existing buildings compliant with the ADA is expensive and complex. For example, a hotel with a fire alarm system installed prior to the ADA becoming effective may be required to reconfigure the fire alarm system or add an auxiliary system. It would be desirable to implement a supplemental alerting system that complements an existing fire alarm system.

### SUMMARY OF THE INVENTION

In view of the foregoing, a supplemental alerting system for a fire alarm system is provided. An exemplary system comprises an alarm control device that generates a fire alarm code signal based on detecting an alarm mode of a fire alarm system. A power line notification appliance (PLNA) generates at least one of a PLNA audible and PLNA visual fire alarm based on the fire alarm code signal. The alarm mode of the fire alarm system may be indicated by a voltage polarity reversal of a fire alarm control signal transmitted from the fire alarm system.

In other features, the system further comprises main power supply lines that power and electrically connect the alarm control device and the PLNA. The alarm control device and the PLNA communicate based on spread spectrum technology. The PLNA generates at least one of the audible and visual alarms until the active fire alarm control signal ceases. The alarm control device transitions to a supervisory mode after the fire alarm system receives a manual reset by an operator of the fire alarm system.

In other features, the alarm control device selectively polls the PLNA by transmitting an acknowledge command to the PLNA based on an encoded address of the PLNA and the PLNA transmits an acknowledgement response when the PLNA respectively receives and processes the acknowledge command. The alarm control device retransmits the acknowledge command to the PLNA when the PLNA fails to transmit the acknowledgement response. The alarm control device indicates a fault condition when the PLNA fails to transmit the acknowledgement response after the alarm control device transmits a pre-selected number (e.g., three) of consecutive acknowledge commands.

In other features, the alarm control device illuminates a fault indicator that corresponds to the PLNA and/or activates an audible alarm when the PLNA fails to transmit the acknowledgement response after the alarm control device transmits the pre-selected number of consecutive acknowledge commands. The acknowledge command includes an encoded address of the PLNA and an all alarm address.

In other features, the PLNA includes non-emergency alarm indicators for non-fire events such as the telephone. The PLNA illuminates a non-emergency PLNA alarm indicator based on receiving a non-emergency alarm notification signal from a RF transmitter. The RF transmitter generates the non-emergency notification signal based on a status change of a device such as a phone associated with the RF transmitter.

Further areas of applicability of the present invention will become apparent from the detailed description provided hereinafter. It should be understood that the detailed description and specific examples, while indicating the preferred embodiment of the invention, are intended for the purpose of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram of a supplemental fire alerting system;

FIG. 2 illustrates an alarm control device of the supplemental alerting system;

FIG. 3 illustrates an alarm control device panel of the supplemental alerting system;

FIG. 4 is a functional block diagram of an exemplary room implementing the supplemental alerting system;

FIG. 5 is a functional block diagram of a plurality of exemplary rooms implementing the supplemental alerting system;

FIG. 6A is a side view of a power line notification appliance of the supplemental alerting system;

FIG. 6B is a front view of the power line notification appliance of the supplemental alerting system; and

FIG. 7 is a flow diagram for operating the supplemental alerting system.

### DETAILED DESCRIPTION OF THE PREFERRED EMBODIMENTS

The following description is merely exemplary in nature and is in no way intended to limit the disclosure, its application, or uses. For purposes of clarity, the same reference numbers are used in the drawings to identify similar elements. As used herein, the term module, circuit and/or device refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical or. It should be understood that steps within a method may be executed in different order without altering the principles of the present disclosure.

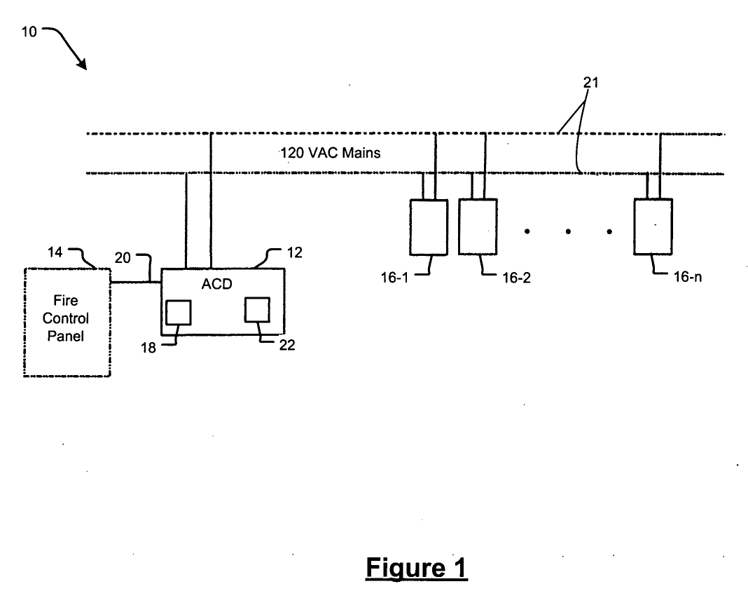

Referring to FIG. 1, the supplemental alerting system 10 includes an alarm control device (ACD) 12, a fire control panel 14, and a plurality of power line notification appliances (PLNAs), 16-1, 16-2, . . . , and 16-n, referred to collectively as PLNAs 16. The ACD 12 includes an ACD panel 18 that interfaces with the fire control panel 14 and the PLNAs 16. The ACD 12 also includes a low current opto-isolator (not shown) that monitors a 24 direct current voltage (VDC) signal generated by the fire control panel 14. The ACD 12 communicates with the fire control panel 14 via a standard two-wire interface circuit 20. In the present implementation, the two-wire interface circuit 20 draws less than 1 milliampere (mA) of current during an alarm mode and approximately 10 microamperes of current during a supervisory mode.

The ACD 12 communicates with the PLNAs 16 via 120 alternating current voltage (VAC) main power lines (mains) 21 using various forms of VAC power line communication such as spread spectrum technology. Spread spectrum technology enables reliable communication between the ACD 12 and each of the PLNAs 16 based in part on a limited susceptibility to electrical power line noise. Additionally, spread spectrum signals typically do not interfere with the operation of various other devices (not shown) of an associated fire alarm system. The 120 VAC mains 21 also supply the ACD 12 with power. The ACD 12 may also include an ACD rechargeable backup battery 22 that provides power in the event of a power transmission loss from the 120 VAC mains 21 to the ACD 12.

During alarm mode operation, the ACD 12 sends a fire alarm code signal, or an all alarm address, to each of the PLNAs 16 when the ACD 12 detects an alarm mode such as a voltage polarity reversal of the 24 VDC fire alarm control signal generated by the fire control panel 14. The fire alarm code signal may include, but is not limited to, a direct sequence spread spectrum signal that operates over a wide frequency range. In the present implementation, the fire alarm code signal indicates a fire alarm.

The ACD 12 selectively transmits a fire alarm code signal via the 120 VAC mains 21 to the PLNAs 16 based on encoded addresses assigned to each of the PLNAs 16. Each of the PLNAs 16 stores a respective encoded address in non-volatile memory such as flash memory. In the present implementation, each encoded address includes an 8 bit value, though other implementations are contemplated.

The respective PLNAs 16 generate an emergency stimulus including, but not limited to, an audible and/or visual alarm based on receiving the fire alarm code signal from the ACD 12. Each of the PLNAs 16 generates the emergency stimulus for a limited duration (e.g., ten seconds) based on receiving a fire alarm code signal. The ACD 12 periodically retransmits the fire alarm code signal if the ACD 12 continues to detect the alarm mode after a time interval (e.g., every six seconds). In other words, the PLNAs 16 continuously generate the emergency stimulus as long as the ACD 12 detects the alarm mode (e.g., voltage polarity reversal). In various implementations, the ACD 12 can transmit distinct danger alarm code signals to each of the PLNAs 16, respectively, based on the encoded addresses assigned to each of the PLNAs 16. The danger alarm code signals indicate a sequence and/or duration of time for activating the emergency stimulus of each of the PLNAs 16. The ACD 12 generates the danger alarm code signals based on the data transmitted to the ACD 12 from at least one of the PLNAs 16. The data can include, but is not limited to, information indicative of conditions (e.g. temperature and/or oxygen levels) within a detection range of the PLNA 16.

To return the supplemental alerting system 10 to a supervisory mode operation, a user/operator may manually reset the fire control panel 14. The fire alarm code signal maintains priority over various other control and/or data signals transmitted during the alarm and supervisory modes of the supplemental alerting system 10.

During supervisory mode operation, the ACD 12 receives operational power from the 120 VAC mains 21 and controls each of the PLNAs 16. The ACD 12 periodically polls each of the PLNAs 16 to ensure proper communication by transmitting an acknowledge command signal to each of the PLNAs 16 individually based on the respective encoded addresses of each of the PLNAs 16. In the present implementation, the ACD 12 transmits the acknowledge command twice per time interval to each of the PLNAs 16 based on a sequential order of the encoded addresses of the PLNAs 16. The acknowledge command can include, but is not limited to, an encoded address of the respective PLNA 16. Each of the PLNAs 16 respectively transmits an acknowledgement response (e.g., two bits) based on receiving and decoding an acknowledge command. Additionally, each of the PLNAs 16 that receives and decodes the acknowledge command may illuminate an operational light indicating proper operation (e.g. flashing green light). Those skilled in the art will appreciate that various other types of acknowledge commands and/or acknowledgement responses are contemplated.

If at least one of the PLNAs 16 fails to transmit an acknowledgement response, the ACD 12 retransmits the acknowledge command to the respective PLNA 16. A pre-selected number (e.g., three) of consecutive failures by a particular PLNA 16 to respond to the acknowledge command indicates a fault condition. Additionally, if the PLNA 16 fails to receive and decode the acknowledge command within a receiving window (e.g., two minutes), a fault condition exists.

During a fault condition, the ACD 12 enables an audible device and/or illuminates an ACD alarm indicator (e.g., a red light) that corresponds to the PLNA 16 experiencing a fault condition (failed PLNA). In various embodiments, the failed PLNA may also activate a fault stimulus until proper communication with the ACD 12 is restored. As the ACD 12 continues to sequentially poll each of the PLNAs 16, the ACD 12 also continues to poll the failed PLNA 16. If the ACD 12 establishes communication with the failed PLNA 16, the ACD 12 resets the audible device and/or extinguishes the light corresponding to the failed PLNA 16. In the present implementation, all PLNAs 16 remain in the fault condition until proper operation of the failed PLNA is restored. The fault condition can result from various failures including, but not limited to, communication failures, a short circuit within the 120 VAC mains 21, an open circuit within the 120 VAC mains 21, interference, failure of a PLNA 16, failure of the ACD 12, and/or failure of a back up battery 22.

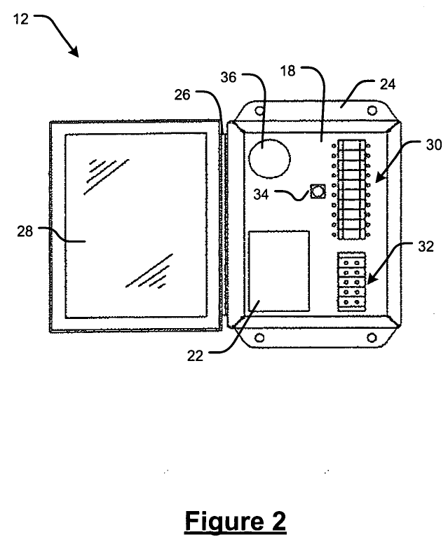

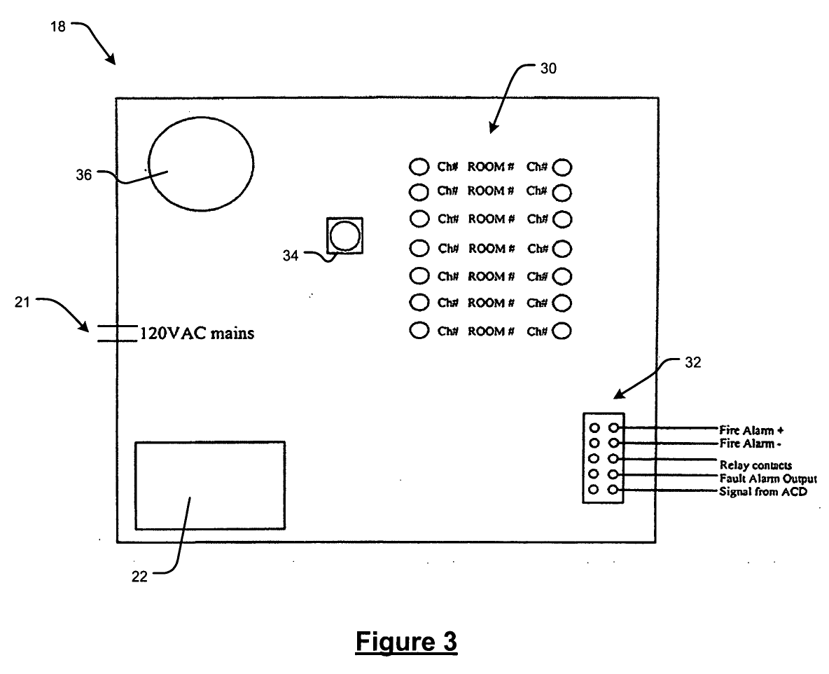

Referring now to FIGS. 2 and 3, the ACD 12 and ACD panel 18 are shown in more detail. The ACD 12 includes a protective (e.g., steel) enclosure 24 having a preferably hinged door 26 that provides access to the ACD panel 18. The hinged door 26 includes a transparent front panel 28 exposing the ACD panel 18. The ACD panel 18 includes the ACD rechargeable backup battery 22, an array of ACD alarm indicators 30, referred to individually as an ACD alarm indicator, a terminal block 32, an alarm test input 34, and an audible alarm device 36.

The array of ACD alarm indicators 30 is visible to a user/operator of the ACD 12 via the front panel 28. Each ACD alarm indicator of the array of ACD alarm indicators 30 corresponds to one of the PLNAs 16. Each of the PLNAs 16 corresponds to a channel associated with a respective operating location (e.g., room, bathroom, or office). The ACD panel 18 includes provisions to identify each indicator based on a channel and location.

The termination block 32 provides terminations for wires (not shown) leading to the fire control panel 14 and for a dry NPFA approved relay contact. The relay contacts close when a fault condition is recorded by the ACD 12 thereby informing a fire control system that the supplemental alerting system 10 is in a fault condition. Additionally, the audible alarm device 36 activates when the supplemental alerting system 10 experiences a fault condition. Upon activating the alarm test input 34, the ACD 12 transmits a fire alarm code signal to each of the PLNAs 16 thereby initiating the alarm mode operation. The ACD 12 returns to the supervisory mode operation upon deactivation of the alarm test input. In the present implementation, the alarm test input includes a pushbutton though other implementations are contemplated such as a touchpad.

As discussed above, the ACD rechargeable battery 22 (e.g., nickel-cadmium battery) is optionally attached to the ACD 12 via the ACD panel 18 to provide power in the event of a power transmission loss from the 120 VAC mains 21 to the ACD 12. The ACD 12 continuously monitors the ACD battery 22 and maintains a charge of the ACD battery 22 close to full capacity. Typically, the ACD battery 22 can continue operation for a pre-selected period of time such as eight (8) hours. A remaining charge capacity left after eight (8) hours of operation is provided to support the alarm mode operation. Each of the PLNAs 16 includes provisions for an optional PLNA rechargeable backup battery that operates in similar fashion to the ACD battery 22. A failure of the ACD battery 22 and/or the PLNA battery results in a fault condition of the supplemental alerting system 10.

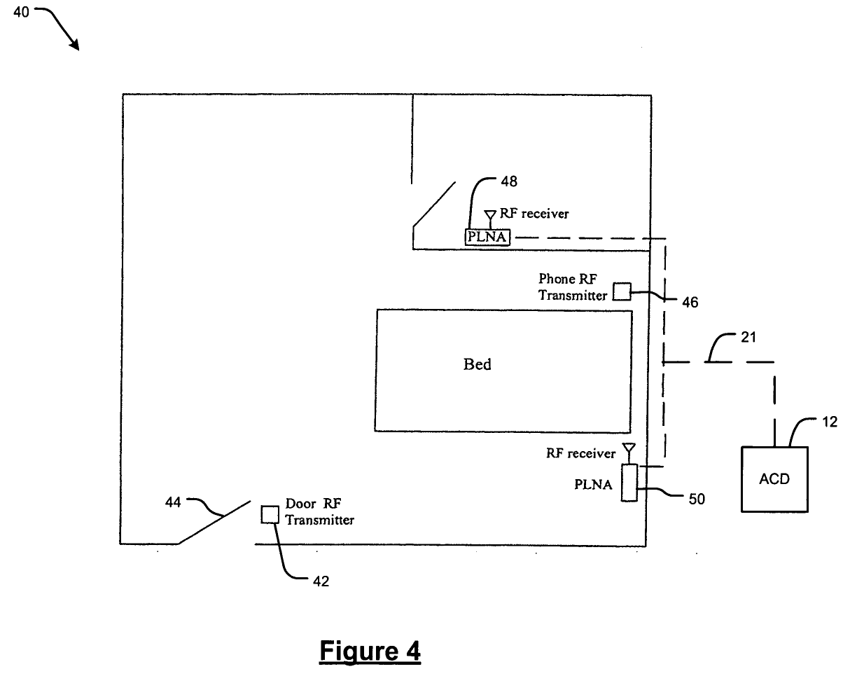

Referring now to FIG. 4, an exemplary hotel room 40 implementing the supplemental alerting system is shown. The hotel room 40 includes a door radio frequency (RF) transmitter 42, a door 44, a phone RF transmitter 46, and the PLNAs 48 and 50. Each of the PLNAs 48 and 50 are optionally equipped with RF receivers. As depicted, the PLNAs 48 and 50 respectively receive power and communicate with the ACD 12 via the 120 VAC mains 21. The RF receivers of the PLNAs 48 and 50 receive non-emergency alarm notification signals from various non-emergency alarm transmitters within the hotel room 40. In the present implementation, PLNAs 48 and 50 respectively communicate with the door RF transmitter 42 and the phone RF transmitter 46 though communication with additional alarm transmitters is contemplated. For example, the door RF transmitter 42 can transmit a door alarm notification signal when a user opens and/or closes a door 44 of hotel room 40. The phone RF transmitter 46 can transmit a phone alarm notification signal when a phone (not shown) within the hotel room 40 receives a call. The hotel room 40 employs an RF system based on a distinct RF address associated with the channel assigned to the hotel room 40. It should be noted that the term “non-emergency” as used herein is meant to distinguish from the fire alarm signal. If desired, an RF based emergency alarm signal may also be provided.

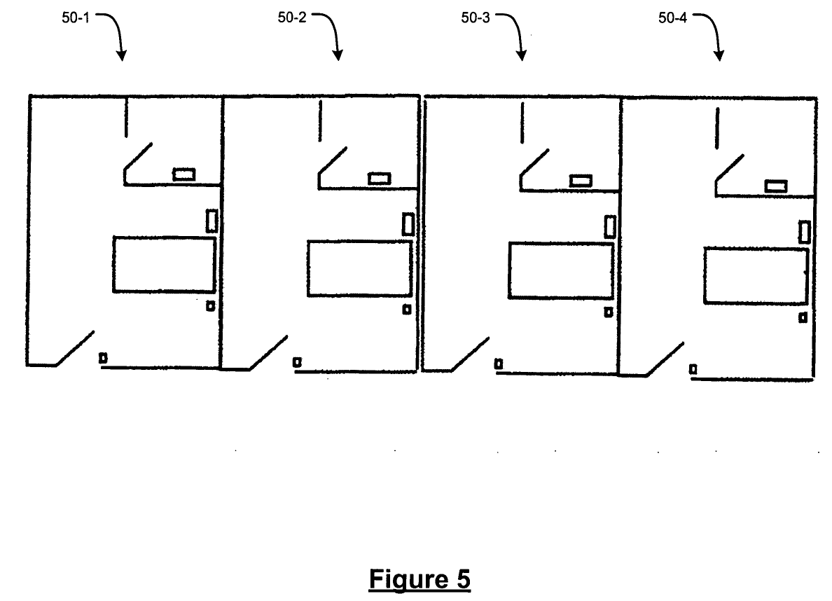

Referring now to FIG. 5, a plurality of hotel rooms is depicted. Hotel rooms 50-1, . . . , and 50-4, referred to collectively as hotel rooms 50, correspond to RF addresses 52-1, . . . , and 52-4, referred to collectively as RF addresses 52, respectively. Each of the hotel rooms 50 employ a distinct RF address 52 resulting in each of the hotel rooms 50 operating independently of each other.

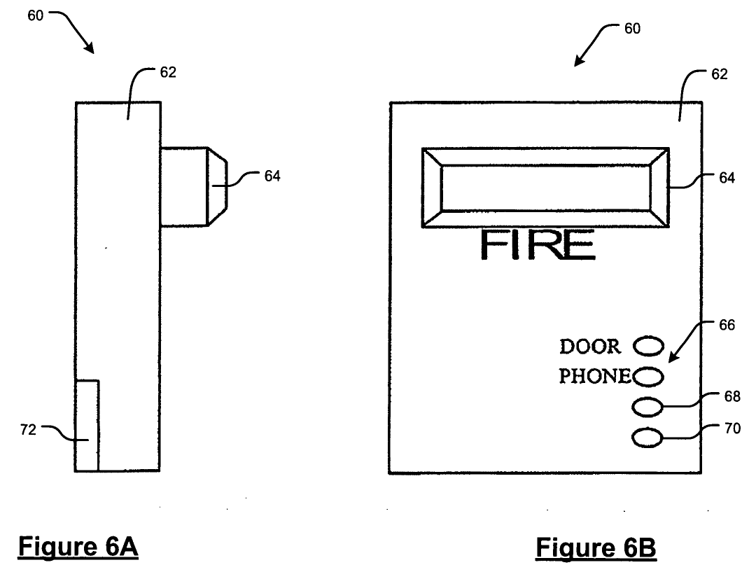

Referring now to FIGS. 6A and 6B, a PLNA 60 is shown in more detail. A sealed protective (e.g., plastic) enclosure 62 houses the PLNA 60 to protect the PLNA 60 from environmental conditions (e.g., humidity). Preferably, the PLNA 60 removably attaches to a wall (not shown) of an operating location via an electric outlet (not shown). Optionally, the PLNA 60 can be hard wired to a fixed position within the operating location. Positioning and location of the PLNA 60 conforms with the National Fire Protection Association requirements for a fire alerting device.

The PLNA 60 includes a PLNA fire alarm indicator 64 and various other non-emergency PLNA alarm indicators 66 including, but not limited to, door and phone alarm indicators. In the present implementation, the PLNA fire alarm indicator 64 includes a Candela strobe light enclosed in a highly reflective enclosure that provides for constant brightness.

The PLNA 60 becomes operational based on receiving power from either the 120 VAC mains 21 or a PLNA backup battery 72. The PLNA backup battery 72 typically requires a “fast charge” for a period of time (e.g. 3 hours) prior to switching to “trickle charge”. The PLNA 60 establishes communication with the ACD 12 once the ACD 12 becomes operational. The ACD 12 determines and stores the encoded address of the PLNA 60 in a non-volatile memory of the ACD 12.

As discussed in FIG. 4, the PLNA 60 can include an optional RF receiver (not shown). The non-emergency PLNA alarm indicators 66 can include door and phone alarm indicators that illuminate based on receiving door and phone alarm signals, respectively. The PLNA 60 can include a program button 68 that instructs the PLNA 60 to determine the addresses of various RF transmitters within a detection proximity or zone based on initializing alarms of the various other alarm transmitters or the activation of the alarm test input 34. The PLNA 60 responds to RF transmitters that the PLNA 60 has been programmed to accept within a detection zone. For example, various RF transmitters communicating with a single PLNA may be located in adjacent hotel rooms. Programming a PLNA to detect specific RF transmitters allows for increased flexibility of operation of the PLNAs. In the present implementation, turning “ON” the program button 68 illuminates the non-emergency PLNA alarm indicators 66 thereby indicating a program mode of the PLNA 60. The non-emergency PLNA alarm indicators 66 cease to illuminate when the PLNA 60 accepts the addresses of the various RF transmitters.

Additionally, the PLNA 60 includes a dual-color indicator light 70 that indicates the operating mode of the PLNA 60 and a PLNA rechargeable backup battery 72.

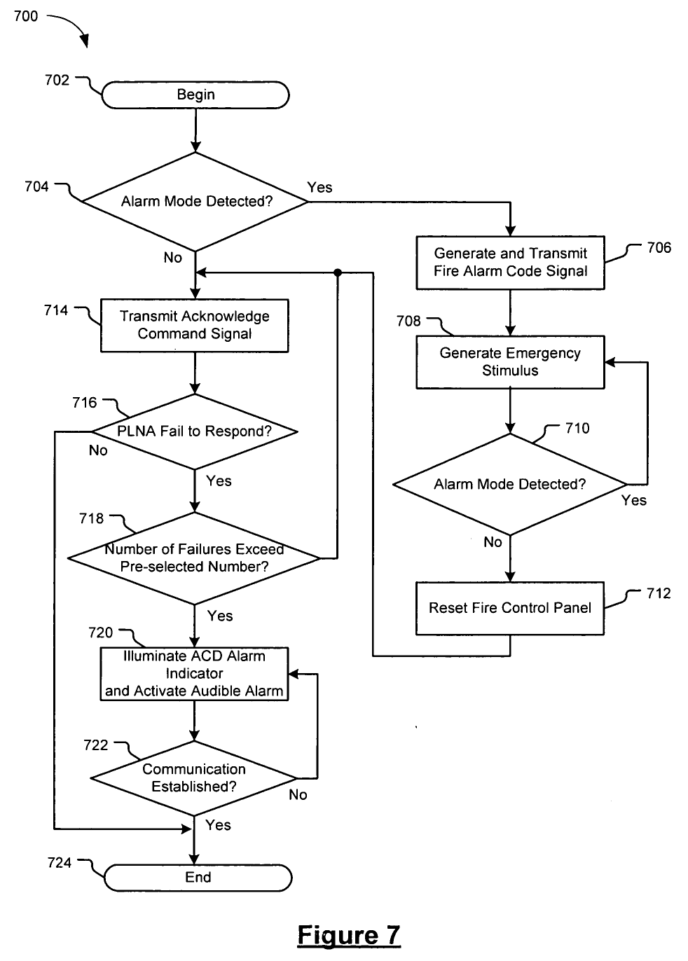

Referring now to FIG. 7, a method 700 for operating the supplemental alerting system 10 is shown. The method 700 begins in step 702 and continues to step 704. In step 704, The ACD 12 determines whether an alarm mode of an associate fire alarm system is detected. If an alarm mode is detected, the method 700 proceeds to step 706. If no alarm mode is detected, the method 700 proceeds to step 714. In step 706, the ACD 12 generates and transmits a fire alarm code signal to each of the PLNAs 16. In step 708, each of the PLNAs 16 generates an emergency stimulus.

In step 710, the ACD 12 determines if an alarm mode continues to be detected. If an alarm mode is still detected, the method 700 returns to step 708. If no alarm mode is detected, the method 700 proceeds to step 712. In step 712 the fire control panel 14 is reset. After step 712, the method 700 continues to step 714. In step 714, the ACD 12 transmits an acknowledge command to each of the PLNAs 16. In step 716, the ACD 12 determines whether a particular PLNA 16 fails to transmit an acknowledgment response to the ACD 12. If the PLNA 16 fails to respond, the method 700 proceeds to step 718. If the PLNA 16 responds, the method 700 proceeds to step 724 and ends.

In step 718, the ACD 12 determines whether the number of failures of the failed PLNA exceeds a pre-selected number. If the number of failures of the failed PLNA has not exceeded the pre-selected number, the method 700 returns to step 714. If the number of failures of the failed PLNA exceeds the pre-selected number, the method 700 proceeds to step 720. In step 720, the ACD 12 illuminates an ACD alarm indicator that corresponds to the failed PLNA and/or enables an audible alarm. In step 722, the ACD 12 determines whether the ACD 12 has established communication with the failed PLNA. If the ACD 12 has not established communication with the failed PLNA, the method 700 returns to step 720. If the ACD 12 has established communication, the method 700 proceeds to step 724 and ends.

The above description is merely exemplary in nature and, thus, variations are intended to be within the scope of the claims. Such variations are not to be regarded as a departure from the spirit and scope of the claims.

What is claimed is:

1. A supplemental alerting system for a fire alarm system, comprising:
an alarm control device that generates a fire alarm code signal based on detecting a fire alarm mode of said fire alarm system; and
a power line notification appliance (PLNA) that generates at least one of a PLNA audible and PLNA visual fire alarm based on said fire alarm code signal.

2. The system of claim 1 further comprising main power supply lines that power and communicatively connect said alarm control device and said PLNA, wherein said alarm control device and said PLNA communicate based on spread spectrum technology.

3. The system of claim 1 wherein said PLNA generates an emergency stimulus until said active fire alarm code signal ceases.

4. The system of claim 3 wherein said alarm control device ceases said fire alarm code signal and transitions to a supervisory mode after said fire alarm system receives a manual reset by an operator of said fire alarm system.

5. The system of claim 1 wherein said alarm control device selectively polls said PLNA by transmitting an acknowledge command to said PLNA based on an encoded address of said PLNA and said PLNA transmits an acknowledgement response to said alarm control device if said PLNA receives and processes said acknowledge command.

6. The system of claim 5 wherein:
said alarm control device retransmits said acknowledge command to said PLNA if said PLNA fails to transmit said acknowledgement response; and
said alarm control device indicates a fault condition if said PLNA fails to transmit said acknowledgement response after said alarm control device transmits a pre-selected number of consecutive acknowledge commands.

7. The system of claim 6 wherein said alarm control device indicates said fault condition by executing at least one of:
illuminating a fault indicator that corresponds to said PLNA; and
activating an audible alarm.

8. The system of claim 5 wherein said acknowledge command includes an encoded address of said PLNA and an all alarm address.

9. The system of claim 1 wherein said PLNA includes an RF receiver and said PLNA illuminates a non-emergency PLNA alarm indicator based on receiving a non-emergency alarm notification signal from a RF transmitter, wherein said RF transmitter generates said non-emergency alarm notification signal based on a status change of a device associated with said RF transmitter.

10. The system of claim 1 wherein said fire alarm mode of said fire alarm system further comprises a voltage polarity reversal of a fire alarm control signal transmitted from said fire alarm system.

11. A supplemental alerting method for a fire alarm system, comprising:
generating a fire alarm code signal of an alarm control device based on detecting an alarm mode of said fire alarm system; and
generating at least one of an audible and visual fire alarm of a power line notification appliance (PLNA) based on said fire alarm code signal.

12. The method of claim 11 wherein said step of generating an emergency stimulus continues until said fire alarm code signal ceases.

13. The method of claim 12 wherein said step of generating a fire alarm code signal ceases after said fire alarm system receives a manual reset by an operator of said fire alarm system.

14. The method of claim 11 further comprising selectively polling said PLNA by transmitting an acknowledge command from said alarm control device based on an encoded address of said PLNA and said PLNA transmitting an acknowledgement response to said alarm control device if said PLNA receives and processes said acknowledge command.

15. The method of claim 14 further comprising retransmitting said acknowledge command from said alarm control device to said PLNA if said PLNA fails to transmit said acknowledgement response to said alarm control device and indicating a fault condition if said PLNA fails to transmit said acknowledgement response after transmitting a pre-selected number of consecutive acknowledge commands.

16. The method of claim 15 wherein said step of indicating a fault condition further comprises causing said alarm control device to execute at least one of:
illuminating a fault indicator that corresponds to said PLNA;.and activating an audible alarm.

17. The method of claim 14 wherein said acknowledge command includes an encoded address of said PLNA and an all alarm address.

18. The method of claim 11 further comprising illuminating a non-emergency PLNA alarm indicator of said PLNA based on receiving a non-emergency alarm notification signal from a RF transmitter, wherein said RF transmitter generates said non-emergency alarm notification signal based on a status change of a device associated with said RF transmitter.

19. The method of claim 11 wherein said fire alarm mode of said fire alarm system further comprises a voltage polarity reversal of a fire alarm control signal transmitted from said fire alarm system.

20. The method of claim 11 wherein said alarm control device and said PLNA communicate based on spread spectrum technology.
